(19) United States
(12) Patent Application Publication
(10) Pub. No.: US 2026/0187478 A1
(43) Pub. Date: Jul. 2, 2026

(54) TRANSFER LEARNING DEVICE AND TRANSFER LEARNING METHOD

(71) Applicant: MEDIATEK INC., Hsinchu City (TW)

(72) Inventors: Wei-Hsu CHU, Hsinchu City (TW); Ting-Ying LI, Hsinchu City (TW); Hsin-Ying LIEN, Hsinchu City (TW)

(21) Appl. No.: 19/428,849

(22) Filed: Dec. 22, 2025

Related U.S. Application Data
(60) Provisional application No. 63/740,412, filed on Dec. 31, 2024.

(51) Int. Cl. G06N 3/096; G06N 3/045

(52) U.S. Cl. CPC G06N 3/096; G06N 3/045

(57) ABSTRACT

A transfer learning device includes a memory and a processor. The memory is configured to store a plurality of commands and framework data. The processor is configured to execute the following steps according to the commands from the memory. The processor sets first model data to enhance network throughput data, energy efficiency data, or both. The processor collects a plurality of training data and triggers the framework data according to the training data. The processor updated the weight data of the first model data based on the framework data. The processor generates second model data by optimizing the first model data based on the weight data of the first model data for current environment data, requirement data, or both. The processor outputs the second model data.

### CROSS REFERENCE TO RELATED APPLICATIONS

This Application claims priority of U.S. Provisional Application No. 63/740,412, filed on Dec. 31, 2024, the entirety of which is incorporated by reference herein.

### BACKGROUND OF THE INVENTION

### FIELD OF THE INVENTION

The present invention relates to a learning device and a learning method, and, in particular, it is related to a transfer learning device and a transfer learning method.

### Description of the Related Art

Currently, most modem microcontrollers (Modem MCUs) are closed systems. In most cases, the essential basic data or references required by a Modem MCU are stored in a corresponding memory before shipment.

In general, a Modem MCU is typically resource-constrained, with limited processing power, memory, and energy availability.

Furthermore, since the data referenced by existing Modem MCUs are predetermined, Modem MCUs are unable to perform self-learning or self-calibration, resulting in output information that is relatively rigid or fixed.

In addition, it is difficult for Modem MCUs to achieve self-learning through the incorporation of algorithms or artificial intelligence models. Even if such algorithms or models are integrated, the closed system architecture limits the Modem MCU's ability to flexibly perform self-calibration or learning.

However, in recent years, the adoption of algorithms and artificial intelligence models for self-learning has become a trend across various fields, with some even incorporating transfer learning techniques. Implementing transfer learning in a Modem MCU is particularly challenging compared to general devices.

In view of the above, a control device capable of performing self-learning and transfer learning is an urgent subject that requires further research.

### BRIEF SUMMARY OF THE INVENTION

An embodiment of the present invention provides a transfer learning device. The transfer learning device includes a memory and a processor. The memory is configured to store a plurality of commands and framework data. The processor is configured to execute following steps according to the plurality of commands of the memory: setting first model data to enhance network throughput data and/or energy efficiency data; collecting a plurality of training data; triggering the framework data according to the plurality of training data; updating weight data of the first model data based on the framework data; generating second model data by optimizing the first model data based on the weight data of the first model data for current environment data and/or requirement data; and outputting the second model data. The plurality of training data is related to the network throughput data and/or the energy efficiency data. The framework data is related to transfer learning data.

In one embodiment, the processor includes a microcontroller and a modem microcontroller; wherein the transfer learning data includes tensorflow lite micro data.

In one embodiment, the framework data includes an enhanced tensorflow lite micro framework data; wherein the first model data includes neural network model data; wherein the tensorflow lite micro data is related to the modem microcontroller; wherein the framework data includes location variability data and application variability data.

In one embodiment, the modem microcontroller executes the following steps according to the plurality of commands of the memory: obtaining a plurality of first weight data from the framework data; and initializing the framework data with a plurality of pre-trained parameters; wherein the plurality of first weight data is related to the weight data of the first model data; wherein the plurality of pre-trained parameters include the plurality of first weight data; wherein the framework data is related to the first model data.

In one embodiment, the modem microcontroller executes the following steps according to the plurality of commands of the memory: calculating batch data according to the requirement data; and updating the plurality of first weight data according to a number of the batch data; wherein the requirement data includes user setting data.

In one embodiment, the modem microcontroller executes the following steps according to the plurality of commands of the memory: obtaining bias data from the framework data; and updating the bias data according to the number of the batch data; wherein the plurality of pre-trained parameters include the bias data.

In one embodiment, the modem microcontroller executes the following steps according to the plurality of commands of the memory: triggering the framework data to perform inference a number of times corresponding to a batch size; and obtaining epoch data according to the number of times corresponding to the batch size; wherein the batch size is related to the batch data.

In one embodiment, the modem microcontroller executes the following steps according to the plurality of commands of the memory: calculating loss data according to the first model data and the second model data; and calculating gradient data according to the loss data and the plurality of first weight data; wherein the first model data and the second model data are related to the framework data.

In one embodiment, the modem microcontroller executes the following steps according to the plurality of commands of the memory: running backward propagation data to update the plurality of first weight data into a plurality of second weight data in a first node according to the loss data and/or the gradient data; setting the plurality of second weight data in a second node; and returning the loss data and validation result data to the framework data; wherein the memory includes the plurality of first weight data; wherein the memory includes the first node; wherein the framework data includes the second node.

In one embodiment, the modem microcontroller executes the following steps according to the plurality of commands of the memory: calculating the loss data through a Mean Squared Error method; collecting the gradient data according to the epoch data; and running the backward propagation data through an optimizer; wherein the optimizer includes one of an Adaptive Moment Estimation and a Root Mean Square Propagation.

Other embodiment of the present invention provides a transfer learning method. The transfer learning method includes the following steps: setting first model data to enhance network throughput data and/or energy efficiency data; collecting a plurality of training data; triggering framework data according to the plurality of training data; updating weight data of the first model data based on the framework data; generating second model data by optimizing the first model data based on the weight data of the first model data for current environment data and/or requirement data; and outputting the second model data; wherein the plurality of training data is related to the network throughput data and/or the energy efficiency data; wherein the framework data is related to transfer learning data.

In one embodiment, the transfer learning method further includes the following steps: triggering framework data by a modem microcontroller; updating the weight data of the first model data based on the framework data by the modem microcontroller; and generating the second model data by optimizing the first model data based on the weight data of the first model data by the modem microcontroller; wherein the transfer learning data includes tensorflow lite micro data.

In one embodiment, the framework data includes an enhanced tensorflow lite micro framework data; wherein the first model data includes neural network model data; wherein the tensorflow lite micro data is related to the modem microcontroller; wherein the framework data includes location variability data and application variability data.

In one embodiment, the transfer learning method further includes the following steps: obtaining a plurality of first weight data from the framework data by a modem microcontroller; and initializing the framework data with a plurality of pre-trained parameters by the modem microcontroller; wherein the plurality of first weight data is related to the weight data of the first model data; wherein the plurality of pre-trained parameters include the plurality of first weight data; wherein the framework data is related to the first model data.

In one embodiment, the transfer learning method further includes the following steps: calculating batch data according to the requirement data by the modem microcontroller; and updating the plurality of first weight data according to a number of the batch data by the modem microcontroller; wherein the requirement data includes user setting data.

In one embodiment, the transfer learning method further includes the following steps: obtaining bias data from the framework data by the modem microcontroller; and updating the bias data according to the number of the batch data by the modem microcontroller; wherein the plurality of pre-trained parameters include the bias data.

In one embodiment, the transfer learning method further includes the following steps: triggering the framework data to perform inference a number of times corresponding to a batch size by the modem microcontroller; and obtaining epoch data according to the number of times corresponding to the batch size by the modem microcontroller; wherein the batch size is related to the batch data.

In one embodiment, the transfer learning method further includes the following steps: calculating loss data according to the first model data and the second model data by the modem microcontroller; and calculating gradient data according to the loss data and the plurality of first weight data by the modem microcontroller; wherein the first model data and the second model data are related to the framework data.

In one embodiment, the transfer learning method further includes the following steps: running backward propagation data to update the plurality of first weight data into a plurality of second weight data in a first node according to the loss data and/or the gradient data by the modem microcontroller; setting the plurality of second weight data in a second node by the modem microcontroller; and returning the loss data and validation result data to the framework data by the modem microcontroller; wherein the memory includes the plurality of first weight data; wherein the memory includes the first node; wherein the framework data includes the second node.

In one embodiment, the transfer learning method further includes the following steps: calculating the loss data through a Mean Squared Error method by the modem microcontroller; collecting the gradient data according to the epoch data by the modem microcontroller; and running the backward propagation data through an optimizer by the modem microcontroller; wherein the optimizer includes one of an Adaptive Moment Estimation and a Root Mean Square Propagation.

Therefore, according to the technical content of the present disclosure, the transfer learning device and transfer learning method shown in the embodiment of the present disclosure can achieve the effect of performing self-learning and transfer learning in the modem microcontroller.

Other features and aspects of the present disclosure will become apparent from the following detailed description of exemplary embodiments with reference to the accompanying drawings.

After reviewing the embodiments described below, those having ordinary skill in the art will readily understand the basic spirit and other objectives of the present invention, as well as the technical means and implementation modes adopted by the present invention.

### BRIEF DESCRIPTION OF THE DRAWINGS

The views of the embodiments of the present disclosure can be better understood through the following detailed description combined with the accompanying drawings. It is worth noting that, according to standard industrial practice, some features may not be drawn to scale. In fact, to facilitate clear description, the dimensions of different features may be increased or decreased, wherein:

FIG. 1 is a block diagram of a transfer learning device according to one embodiment of the present disclosure.

FIG. 2 is a schematic flowchart of a plurality of steps of a transfer learning device according to one embodiment of the present disclosure.

FIG. 3 is a schematic flowchart of a transfer learning method according to one embodiment of the present disclosure.

According to conventional practice, the various features and components illustrated in the drawings are depicted in a manner that best represents the specific features and components relevant to the present invention. In addition, in different figures, identical or similar reference numerals are used to denote identical or similar elements or components.

### DETAILED DESCRIPTION OF THE INVENTION

The following description is made for the purpose of illustrating the general principles of the invention and should not be taken in a limiting sense. The scope of the invention is best determined by reference to the appended claims.

The word “embodiment” as used herein means “serving as an example, example, or illustrative.” Any embodiment described herein as “embodiment” is not necessarily to be construed as superior or superior to other embodiments.

In addition, in order to better explain the present disclosure, numerous specific details are provided in the following specific embodiments. It will be understood by those skilled in the art that the present disclosure may be practiced without certain specific details. In some instances, methods, means, components and circuits that are well known to those skilled in the art are not described in detail in order to highlight the gist of the disclosure.

To make the description of the present disclosure more detailed and complete, illustrative descriptions are provided below for the implementation aspects and specific embodiments of the present case. However, this is not the sole form of implementing or utilizing the specific embodiments of the present case.

The embodiments cover the features of multiple specific embodiments as well as the method steps and their sequence for constructing and operating these specific embodiments. Nevertheless, the same or equivalent functions and sequence of steps can also be achieved using other specific embodiments.

Unless otherwise defined in this specification, the meaning of scientific and technical terms used herein is the same as commonly understood and customary by a person having ordinary skill in the art to which the present case pertains. Furthermore, without conflicting with the context, singular nouns used in this specification cover their plural forms; and plural nouns also cover their singular forms.

In some embodiments of the present disclosure, terms related to joining and connecting, such as “connect,” “interconnect,” and “bond,” unless specifically defined otherwise, may refer to situations where two structures are in direct contact, or may also refer to situations where two structures are not in direct contact, with other structures arranged between these two structures.

Moreover, these terms related to connecting and joining may also include cases where both structures are movable, or both structures are fixed. Additionally, “coupled” or “connected” as used herein may refer to two or more components being in direct physical or electrical contact with each other, or indirect physical or electrical contact with each other, and may also refer to two or more components interacting or operating with each other.

Some embodiments of the present disclosure can be understood in conjunction with the drawings, and the drawings of the embodiments of the present disclosure are also considered as part of the description of the embodiments of the present disclosure. It should be understood that the drawings of the embodiments of the present disclosure are not drawn to the actual scale of devices and components.

The shapes and thicknesses of the embodiments may be exaggerated in the drawings to clearly illustrate the features of the embodiments of the present disclosure. Furthermore, the structures and devices in the drawings are schematically illustrated to clearly illustrate the features of the embodiments of the present disclosure.

Herein, the term “apparatus” generally refers to an object connected in a certain way to process signals, composed of one or more transistors and/or one or more active/passive components.

Here, the terms “about,” “approximately,” and “roughly” generally indicate within 20% of a given value or range, preferably within 10%, and more preferably within 5%, or within 3%, or within 2%, or within 1%, or within 0.5%. The quantities given herein are approximate quantities, meaning that the meaning of “about,” “approximately,” or “roughly” may still be implicitly included even without specific mention of “about,” “approximately,” or “roughly”.

The term “a range between a first value and a second value” means that the described range includes the first value, the second value, and other values between them. Furthermore, a certain error may exist between any two values or directions used for comparison. If the first value is equal to the second value, it implies that there may be an error of about 10%, or within 5%, or within 3%, or within 2%, or within 1%, or within 0.5% between the first value and the second value.

If the first direction is perpendicular to the second direction, the angle between the first direction and the second direction may be between 80 degrees and 100 degrees. If the first direction is parallel to the second direction, the angle between the first direction and the second direction may be between 0 degrees and 10 degrees.

Certain terms will be used throughout the entire specification and claims of the present disclosure to refer to specific components. A person having ordinary skill in the art should understand that electronic device manufacturers may refer to the same components by different names. This document is not intended to distinguish between components that have the same function but different names.

In the following specification and claims, terms such as “comprising” “containing” and “having” are open-ended terms, and therefore they should be interpreted as “containing but not limited to...”. Thus, when the terms “comprising” “containing” and/or “having” are used in the description of the present disclosure, they specify the presence of corresponding parts, regions, steps, operations, and/or elements, but do not exclude the presence of one or more corresponding parts, regions, steps, operations, and/or elements.

It should be understood that the components from multiple different embodiments can be substituted, rearranged, and combined to complete other embodiments without departing from the spirit of the present disclosure. Components between various embodiments can be arbitrarily combined and used together, as long as they do not violate the spirit of the invention or conflict with each other.

Unless otherwise defined, all terms used herein (including technical and scientific terms) have the same meaning as commonly understood by a person having ordinary skill in the art to which the present disclosure pertains. It can be understood that these terms, for example, terms defined in commonly used dictionaries, should be interpreted as having a meaning consistent with the relevant art and the background or context of the present disclosure, and should not be interpreted in an idealized or overly formal sense, unless specifically defined in the embodiments of the present disclosure.

In the present disclosure, various directions are not limited to the three axes like the X-axis, Y-axis, and Z-axis of a Cartesian coordinate system, and can be interpreted in a broader sense. For example, the X-axis, Y-axis, and Z-axis may be perpendicular to each other, or may represent different directions that are not perpendicular to each other, but are not limited thereto.

For convenience of description, hereinafter, the X-axis direction is the first direction (width direction), the Y-axis direction is the second direction (length direction), and the Z-axis direction is the third direction (thickness or height direction). In some embodiments, the cross-sectional schematic view described herein is a cross-sectional schematic view observed in the XZ plane. In some embodiments, the third direction may be the normal direction of the substrate. In some embodiments, the third direction may be the front direction of the Transfer learning device.

In some embodiments, additional components may be added to the Transfer learning device of the present disclosure. In some embodiments, some components of the Transfer learning device of the present disclosure may be replaced or omitted. In some embodiments, additional operational steps may be provided before, during, and/or after the manufacturing method of the Transfer learning device. In some embodiments, some of the described operational steps may be replaced or omitted, and the sequence of some of the described operational steps is interchangeable. Furthermore, it should be understood that some of the described steps may be replaced or deleted for other embodiments of the method. Moreover, in the present disclosure, the number and size of each component in the drawings are for illustrative purposes only, and are not intended to limit the scope of the present disclosure.

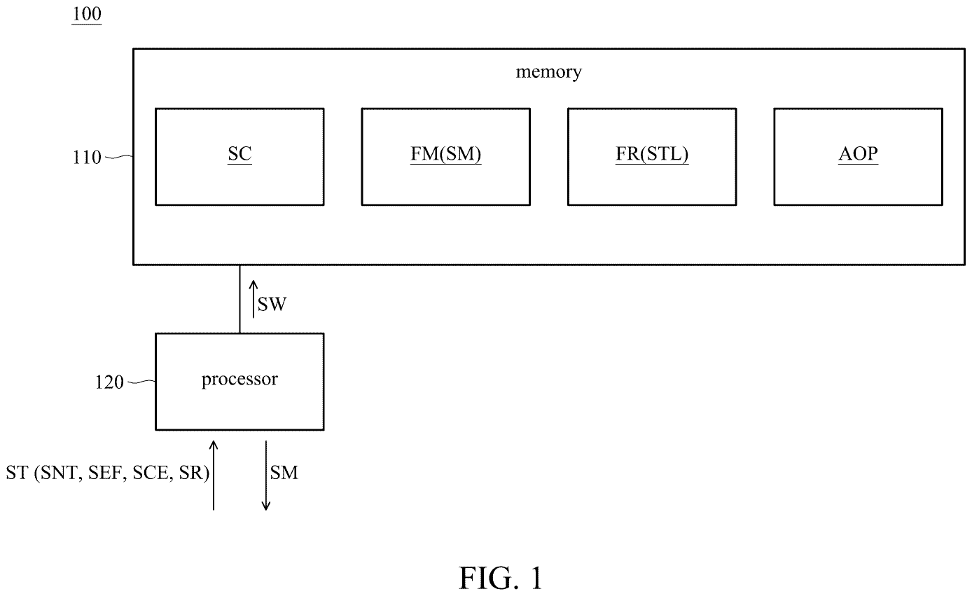

FIG. 1 is a block diagram of a transfer learning device according to one embodiment of the present disclosure. As shown in FIG. 1, in one embodiment, the transfer learning device 100 includes a memory 110 and a processor 120. The memory 110 is configured to store a plurality of commands SC and framework data FR.

Regarding the connection relationship, the memory 110 may be coupled to the processor 120.

In some embodiments, the memory 110 may further include first model data FR, second model data SM, and an operation area AOP, but the present disclosure is not limited thereto.

In some embodiments, the operation (op) area AOP may be a retrain op node, and the operation area AOP may store a plurality weight data, but the present disclosure is not limited thereto.

In some embodiments, the processor 120 may be a modem microcontroller, a system-on-chip (SoC), a microprocessor unit (MPU), a central processing unit (CPU), a graphics processing unit (GPU), a microcontroller unit (MCU), a microprocessor, a digital signal processor (DSP), a field programmable gate array (FPGA), an application-specific integrated circuit (ASIC), or a server, among others. However, the present disclosure is not limited thereto.

In some embodiments, the memory 110 may be a random-access memory (RAM), a read-only memory (ROM), a cache, a flash memory, a memory card, a hard disk (such as a cloud/network hard disk or an external hard disk), an optical disc, a USB flash drive, or a database, among others. However, the present disclosure is not limited thereto.

In some embodiments, plurality of commands SC of the memory 110 may be any type of programming language code, algorithm, software, or firmware, among others. However, the present disclosure is not limited thereto.

In some embodiments, the framework data FR may be performed by the modem microcontroller, but the present disclosure is not limited thereto.

In some embodiments, the framework data FR may be related to any type of artificial neural network (ANN) model, any type of big data algorithm, any type of machine learning algorithm, any type of artificial intelligence (AI) algorithm, or any type of Chat Generative Pre-trained Transformer (ChatGPT) algorithm, among others. However, the present disclosure is not limited thereto.

In one embodiment, the processor 120 is configured to execute the following steps according to the plurality of commands of the memory 110: setting first model data FM to enhance network throughput data SNT and/or energy efficiency data SEF; and collecting a plurality of training data ST.

For example, the network throughput data SNT may be related to the network throughput of the processor 120 (or the modem microcontroller), the energy efficiency data SEF may be related to the energy efficiency of the processor 120 (or the modem microcontroller), the plurality of training data ST may be related to the processor 120 (or the modem microcontroller), but the present disclosure is not limited thereto.

In some embodiments, during the initial AI model deployment period, the AI feature (such as the first model data FR) designed to optimize network throughput (TPUT) is initially deployed to enhance the performance of the modem MCU. This model operates alongside the existing rule-based methods, providing improvements in areas such as TPUT or energy efficiency), but the present disclosure is not limited thereto.

In some embodiments, during the fallback to rule-based methods period, the system (such as the transfer learning device 100) detects that the AI model's performance has become inaccurate due to changes in the environment or user behavior. In response, the system (such as the transfer learning device 100) automatically switches to the rule-based method for managing network throughput. This ensures that the device continues to operate effectively while collecting valuable training data (such as the plurality of training data ST), but the present disclosure is not limited thereto.

In some embodiments, during the data collection period, while operating under the rule-based method, the system (such as the transfer learning device 100) collects data (such as the plurality of training data ST) on network conditions, user behavior, and performance metrics. This data (such as the plurality of training data ST) is essential for fine-tuning the AI model (such as the first model data FR, the second model data SM, or the framework data FR), but the present disclosure is not limited thereto.

In some embodiments, the first model data FM may include an artificial intelligence model or algorithm. The first model data FM may be any type of artificial neural network (ANN) model, any type of big data algorithm, any type of machine learning algorithm, any type of artificial intelligence (AI) algorithm, or any type of Chat Generative Pre-trained Transformer (ChatGPT) algorithm, among others. However, the present disclosure is not limited thereto.

In some embodiments, the first model data FM may be related to the framework data FR, but the present disclosure is not limited thereto.

In some embodiments, the first model data FM may be related to the second model data SM, and the second model data SM may be fine-tuned from the first model data FR, but the present disclosure is not limited thereto.

In one embodiment, the processor 120 is configured to execute the following steps according to the plurality of commands of the memory 110: triggering the framework data FR according to the plurality of training data ST; updating weight data SW of the first model data FM based on the framework data FR; generating second model data by optimizing the first model data based on the weight data SW of the first model data FM for current environment data SCE and/or requirement data SR; and outputting the second model data SM.

For example, the current environment data SCE may be related to the current environment of the processor 120 (or the modem microcontroller), the requirement data SR may be the user requirement or the processor 120 (or the modem microcontroller) requirement, but the present disclosure is not limited thereto.

In some embodiments, the processor 120 may trigger the framework (such as the framework data FR) to perform on-device training and update the AI model with the training data (such as the plurality of training data ST), but the present disclosure is not limited thereto.

In some embodiments, the requirement data SR may be defined by a specification or a lookup table, but the present disclosure is not limited thereto.

In some embodiments, the processor 120 may output the second model data SM t the memory 110 and replace the first model data FM, but the present disclosure is not limited thereto.

In some embodiments, once a sufficient amount of training data (such as the plurality of training data ST) has been collected, the transfer learning framework (such as the framework data FR) is triggered. This framework utilizes the collected data to update the model weights (such as the weight data SW of the first model data FM), ensuring that the AI model is fine-tuned and optimized for the current environment and user requirements, but the present disclosure is not limited thereto.

In some embodiments, after the transfer learning process is completed, the fine-tuned AI model (such as the second model SM) is deployed. The system (such as the transfer learning device 100) then resumes using the AI model for optimized network throughput, continuously monitoring its accuracy and effectiveness, but the present disclosure is not limited thereto.

In one embodiment, the plurality of training data ST is related to the network throughput data SNT and/or the energy efficiency data SEF. The framework data FR is related to the transfer learning data STL.

For example, the transfer learning data STL may include any transfer learning algorithm performed by the modem microcontroller, but the present disclosure is not limited thereto.

In some embodiments, in general technology (efficient real-time transfer learning framework on resource-constrained platforms), the challenge of efficient transfer learning on resource-constrained platforms, such as the modem MCU, is significant due to its limited resources. Traditionally, training frameworks are designed for powerful systems and are not specifically tailored for resource-constrained environments like modem MCU.

Furthermore, the present disclosure will optimize the transfer learning framework for modem MCU. Optimizing the transfer learning framework for a modem MCU involves addressing modem-specific needs. This includes developing lightweight algorithms that may run efficiently on the modem MCU and creating adaptive model parameters that may adjust to different user requirements and environments. The framework must be capable of handling diverse data inputs and supporting real-time fine-tuning, but the present disclosure is not limited thereto.

In one embodiment, the processor 120 includes a microcontroller and a modem microcontroller. The transfer learning data STL includes tensorflow lite micro data.

For example, the processor 120 may be the microcontroller or the modem microcontroller, the transfer learning data STL may be the tensorflow lite micro data (or may be referred to as the TensorFlow Lite Micro algorithm), but the present disclosure is not limited thereto.

In one embodiment, the framework data FR includes an enhanced tensorflow lite micro framework data. The first model data FM includes neural network model data. The tensorflow lite micro data is related to the modem microcontroller. The framework data FR includes location variability data and application variability data.

For example, the framework data FR may be an enhanced framework based on the TensorFlow Lite Micro algorithm, and the first model data FM may be the neural network (NN) model, but the present disclosure is not limited thereto.

Furthermore, the framework data FR may accommodate location variability and application variability, but the present disclosure is not limited thereto.

The following provides further explanation regarding location variability and application variability.

In some embodiments, Scenario 1: Location Variability. A model pre-trained on data from the New York subway may not perform well in the Boston subway due to differences in the environment and user behavior. Transfer learning allows the model to be fine-tuned with local data, enhancing its accuracy and relevance, but the present disclosure is not limited thereto.

In some embodiments, Scenario 2: Application Variability. Different applications, such as gaming, video streaming, and file transfer, have varying requirements for model performance. A one-size-fits-all model may not meet the specific needs of each application. Transfer learning enables the model to fine-tune itself based on the specific application it is being used for, ensuring optimal performance, but the present disclosure is not limited thereto.

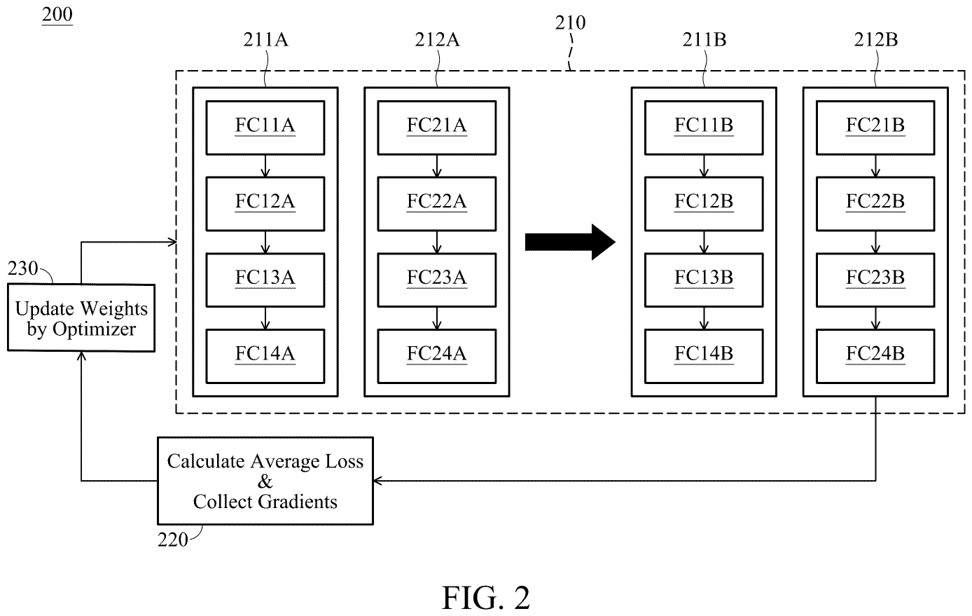

FIG. 2 is a schematic flowchart of a plurality of steps of a transfer learning device according to one embodiment of the present disclosure. As shown in FIG. 2, in one embodiment, the flowchart 200 may include the plurality of steps 210, 220, and 230. The step 210 may include the operation node 211A and 211B and the interpreter 212A and 212B.

In one embodiment, the operation node 211A may have a plurality of weight data FC11A, FC12A, FC13A, and FC14A. In one embodiment, the interpreter 212A may have a plurality of weight data FC21A, FC22A, FC23A, and FC24A.

In one embodiment, the operation node 211B may have a plurality of weight data FC11B, FC12B, FC13B, and FC14B. In one embodiment, the interpreter 212B may have a plurality of weight data FC21B, FC22B, FC23B, and FC24B.

For example, the operation node 211A may correspond to the operation area AOP in FIG. 1, the operation node 211B may correspond to the operation area AOP in FIG. 1, the interpreter 212A may be related to (or correspond to) the framework data FR in FIG. 1, and the interpreter 212B may be related to (or correspond to) the framework data FR in FIG. 1, but the present disclosure is not limited thereto.

In some embodiments, the plurality of weight data FC11A, FC12A, FC13A, and FC14A are related to (or correspond to) the weight data SW in FIG. 1, the plurality of weight data FC21A, FC22A, FC23A, and FC24A are related to (or correspond to) the weight data SW in FIG. 1, the plurality of weight data FC11B, FC12B, FC13B, and FC14B are related to (or correspond to) the weight data SW in FIG. 1, the plurality of weight data FC21B, FC22B, FC23B, and FC24B are related to (or correspond to) the weight data SW in FIG. 1, but the present disclosure is not limited thereto.

In some embodiments, the operation node 211A may set the weights and transfer the weights to the operation node 211B, but the present disclosure is not limited thereto. In some embodiments, the operation node 212A may set the weights and transfer the weights to the operation node 212B, but the present disclosure is not limited thereto.

In some embodiments, the first weight data FC11A may be {w11, w12, . . . , w1n}, the first weight data FC12A may be {w21, w22, . . . , w2n}, the first weight data FC13A may be {w31, w32, . . . , w3n}, and the first weight data FC14A may be {w41, w42, . . . , w4n}, but the present disclosure is not limited thereto.

In this embodiment, the first weight data FC21A may be {t11, t12, . . . , t1n}, the first weight data FC22A may be {t21, t22, . . . , t2n}, the first weight data FC23A may be {t31, t32, . . . , t3n}, and the first weight data FC24A may be {t41, t42, . . . , t4n}, but the present disclosure is not limited thereto.

In this embodiment, the first weight data FC11B may be {w11, w12, . . . , w1n}, the first weight data FC12B may be {w21, w22, . . . , w2n}, the first weight data FC13B may be {w31, w32, . . . , w3n}, and the first weight data FC14B may be {w41, w42, . . . , w4n}, but the present disclosure is not limited thereto.

In this embodiment, the first weight data FC21B may be {w11, w12, . . . , w1n}, the first weight data FC22B may be {w21, w22, . . . , w2n}, the first weight data FC23B may be {w31, w32, . . . , w3n}, and the first weight data FC24B may be {w41, w42, . . . , w4n}, but the present disclosure is not limited thereto.

In some embodiments, the first weight data FC11A may be {t11, t12, . . . , t1n}, the first weight data FC12A may be {t21, t22, . . . , t2n}, the first weight data FC13A may be {t31, t32, . . . , t3n}, and the first weight data FC14A may be {t41, t42, . . . , t4n}, but the present disclosure is not limited thereto.

In this embodiment, the first weight data FC21A may be {t11, t12, . . . , t1n}, the first weight data FC22A may be {t21, t22, . . . , t2n}, the first weight data FC23A may be {t31, t32, . . . , t3n}, and the first weight data FC24A may be {t41, t42, . . . , t4n}, but the present disclosure is not limited thereto.

In this embodiment, the second weight data FC11B may be {w11, w12, . . . , w1n}, the second weight data FC12B may be {w21, w22, . . . , w2n}, the second weight data FC13B may be {w31, w32, . . . , w3n}, and the second weight data FC14B may be {w41, w42, . . . , w4n}, but the present disclosure is not limited thereto.

In this embodiment, the second weight data FC21B may be {w11, w12, . . . , w1n}, the second weight data FC22B may be {w21, w22, . . . , w2n}, the second weight data FC23B may be {w31, w32, . . . , w3n}, and the second weight data FC24B may be {w41, w42, . . . , w4n}, but the present disclosure is not limited thereto.

In some embodiments, the operation node 211A and the operation node 212A may have different values for the weight data FC11A/FC12A/FC13A/FC14A and the weight data FC21A/FC22A/FC23A/FC24A, respectively.

After execution of step 210 (as indicated by the black arrow), the values stored in the operation node 211A remain unchanged; that is, the weight data FC11B/FC12B/FC13B/FC14B are identical to the weight data FC11A/FC12A/FC13A/FC14A. However, the weight data FC21B/FC22B/FC23B/FC24B are updated to the values of FC11A/FC12A/FC13A/FC14A.

In other words, operation node 211A is equal to operation node 211B and different from operation node 212A prior to step 210. After execution of step 210, the values of the weight data of operation node 212A are updated to match those of operation node 211A, and the updated weight data are referred to as the weight data 212B.

Please refer to FIG. 1 and FIG. 2, the following provides a detailed description of the plurality of steps 210, 220, and 230.

In the step 210, get initial weights & bias from pretrained model.

In one embodiment, the processor 120 (or the modem microcontroller) may getting initial weights data and bias data from pretrained model.

In one embodiment, the processor 120 (or the modem microcontroller) may getting the weight data SW from the first model data FM.

In one embodiment, the modem microcontroller executes the following steps according to the plurality of commands of the memory 110: obtaining a plurality of first weight data FC11A, FC12A, FC13A, and FC14A from the framework data FR; and initializing the framework data FR with a plurality of pre-trained parameters.

In one embodiment, the plurality of first weight data FC11A, FC12A, FC13A, and FC14A is related to the weight data SW of the first model data FM. The plurality of pre-trained parameters include the plurality of first weight data FC11A, FC12A, FC13A, and FC14A. The framework data FR is related to the first model data FM.

In some embodiments, the processor 120 (or the modem microcontroller) may read built-in weights and bias from the TensorFlow Lite Micro (or may be referred to as TFLite model). This step initializes the model with pre-trained parameters, which will be fine-tuned during the transfer learning process, but the present disclosure is not limited thereto.

In one embodiment, the modem microcontroller executes the following steps according to the plurality of commands of the memory 110: calculating batch data according to the requirement data SR; and updating the plurality of first weight data FC11A, FC12A, FC13A, and FC14A according to a number of the batch data.

In one embodiment, the requirement data SR includes user setting data.

For example, the number of the batch data may correspond to the following “batch_num”, but the present disclosure is not limited thereto.

In one embodiment, the modem microcontroller executes the following steps according to the plurality of commands of the memory 110: obtaining bias data from the framework data FR; and updating the bias data according to the number of the batch data.

In one embodiment, the plurality of pre-trained parameters include the bias data.

In some embodiments, the processor 120 (or the modem microcontroller) may calculate “batch_num” by user setting. In details, the processor 120 (or the modem microcontroller) may update weights and bias by each “batch_num”. This step involves determining the number of batches based on user settings, which helps in managing memory usage and improving fine-tuning efficiency, but the present disclosure is not limited thereto.

In the step 220, calculate average loss and collect gradients.

In one embodiment, the processor 120 (or the modem microcontroller) may calculate average loss and collect gradients (from the framework FM).

In one embodiment, the modem microcontroller executes the following steps according to the plurality of commands of the memory: triggering the framework data FR to perform inference a number of times corresponding to a batch size; and obtaining epoch data according to the number of times corresponding to the batch size.

In one embodiment, the batch size is related to the batch data.

For example, the number of times corresponding to a batch size may correspond to the following “batch_size” times, and the epoch data may be the epoch of the framework data FR, but the present disclosure is not limited thereto.

In some embodiments, during training, the framework FM is triggered to perform model inference for each item in the batch, corresponding to the batch size, but the present disclosure is not limited thereto.

In one embodiment, the modem microcontroller executes the following steps according to the plurality of commands of the memory 110: calculating loss data according to the first model data FM and the second model data SM; and calculating gradient data according to the loss data and the plurality of first weight data FC11A, FC12A, FC13A, and FC14A.

In one embodiment, the first model data FM and the second model data SM are related to the framework data FR.

In some embodiments, during the epoch, the processor 120 (or the modem microcontroller) may trigger model inference “batch_size” times. This step involves running the model on a subset of the data to make predictions, but the present disclosure is not limited thereto.

In some embodiments, during each of the epoch, the processor 120 (or the modem microcontroller) may calculate loss and gradients. In details, this involves computing the loss function (such as Mean Squared Error) and the gradients of the loss with respect to the model parameters.

Furthermore, the processor 120 (or the modem microcontroller) may collect gradients. In details, this step accumulates the gradients for each batch, but the present disclosure is not limited thereto.

In some embodiments, the processor 120 (or the modem microcontroller) may train epochs and batch training. A detailed description is provided below.
1. Training Epochs: Introduced the concept of training epochs, where the entire dataset is passed forward and backward through the neural network multiple times. This allows the model to learn and refine its parameters iteratively during the fine-tuning process.
2. Batch Training Method: Implemented batch training, where the dataset is divided into smaller batches. Each batch is used to update the model parameters, which helps in managing memory usage and improving fine-tuning efficiency on resource-constrained devices.

Accordingly, by incorporating these methods, the enhanced TFLM framework supports efficient transfer learning on resource-constrained devices like modem MCU, enabling real-time model adaptation and optimization, but the present disclosure is not limited thereto.

In some embodiments, the processor 120 (or the modem microcontroller) may implement methods for computing the Mean Squared Error (MSE) loss function, which measures the average squared difference between the predicted outputs and the actual targets. This is crucial for guiding the fine-tuning process, but the present disclosure is not limited thereto.

In some embodiments, the processor 120 (or the modem microcontroller) may add functionality to calculate gradients, which are essential for understanding how to adjust the model parameters to minimize the loss. This involves computing the partial derivatives of the loss function with respect to each model parameter, but the present disclosure is not limited thereto.

In the step 230, update weights by optimizer.

In one embodiment, the processor 120 (or the modem microcontroller) may update weights by optimizer.

In one embodiment, the modem microcontroller executes the following steps according to the plurality of commands of the memory 110: running backward propagation data to update the plurality of first weight data FC11A, FC12A, FC13A, and FC14A into a plurality of second weight data FC11B, FC12B, FC13B, and FC14B in a first node according to the loss data and/or the gradient data.

In one embodiment, the modem microcontroller executes the following steps according to the plurality of commands of the memory 110: setting the plurality of second weight data FC21B, FC22B, FC23B, and FC24B in a second node; and returning the loss data and validation result data to the framework data FR.

For example, the plurality of second weight data FC21B, FC22B, FC23B, and FC24B may be same as the plurality of second weight data FC11B, FC12B, FC13B, and FC14B, the first node may correspond to the operation node 211A or 211B, and the second node may correspond to the interpreter 212A or 212B, but the present disclosure is not limited thereto.

In one embodiment, the memory 110 includes the plurality of first weight data FC11A, FC12A, FC13A, and FC14A. The memory 110 includes the first node. The framework data FR includes the second node.

In one embodiment, the modem microcontroller executes the following steps according to the plurality of commands of the memory 110: calculating the loss data through a Mean Squared Error method; collecting the gradient data according to the epoch data; and running the backward propagation data through an optimizer.

In some embodiments, the processor 120 (or the modem microcontroller) may run backward propagation to update weights in “retrain_op_node” (or may be referred to as the operation node 211B). This step adjusts the model parameters based on the collected gradients to minimize the loss, but the present disclosure is not limited thereto.

In some embodiments, the processor 120 (or the modem microcontroller) may set new weights in “TFLiteNode” (or may be referred to as the interpreter 212A or 212B). This updates the model with the new weights after each batch, but the present disclosure is not limited thereto.

In some embodiments, the processor 120 (or the modem microcontroller) may integrate backpropagation algorithms to update the model parameters based on the calculated gradients. This iterative process adjusts the parameters to reduce the loss, effectively fine-tuning the model, but the present disclosure is not limited thereto.

In some embodiments, the processor 120 (or the modem microcontroller) may return loss and validation result. In details, after completing the fine-tuning process, return the final loss and validation results. This provides an indication of the model's performance and its ability to generalize to new data, but the present disclosure is not limited thereto.

In one embodiment, the optimizer includes one of an Adaptive Moment Estimation (ADAM) and a Root Mean Square Propagation (RMSProp).

In some embodiments, the optimizer may be optimization algorithms. The optimization algorithms may include ADAM and RMSProp. A detailed description is provided below.
1. ADAM: Implemented the ADAM optimizer, which combines the advantages of two other extensions of stochastic gradient descent, namely Adaptive Gradient Algorithm (AdaGrad) and Root Mean Square Propagation (RMSProp). ADAM is well-suited for problems with sparse gradients and provides efficient and reliable fine-tuning, but the present disclosure is not limited thereto.
2. RMSProp: Added the RMSProp optimizer, which adjusts the learning rate for each parameter based on the average of recent magnitudes of the gradients for that parameter. This helps in dealing with the vanishing and exploding gradient problems, but the present disclosure is not limited thereto.

In some embodiments, the transfer learning device 100 of the present disclosure may perform the auto training data collection through the transfer learning framework.

In this embodiment, the transfer learning device 100 of the present disclosure may collect training data to trigger transfer learning. In details, one of the key challenges of transfer learning is determining how to collect sufficient training data to trigger the fine-tuning process. Traditionally, modem AI technologies have leveraged AI models to enhance existing rule-based methods, achieving benefits such as improved throughput (TPUT) or energy efficiency. This approach allows the collection of training data through the existing rule-based methods, but the present disclosure is not limited thereto.

In this embodiment, the transfer learning device 100 of the present disclosure may perform integration with Rule-Based Methods. In the framework, the transfer learning device 100 may integrate AI models with rule-based methods to facilitate data collection for transfer learning. The process can be described as follows:
1. Initial AI Model Deployment: Initially, an AI model is deployed to enhance the performance of the modem MCU. This model operates alongside the existing rule-based methods, providing improvements in areas such as TPUT or energy efficiency.
2. Fallback to Rule-Based Methods: If the AI model's performance degrades or becomes inaccurate in certain scenarios, the system automatically falls back to the rule-based methods. This ensures that the device continues to operate effectively while collecting valuable training data.
3. Data Collection: During the fallback period, the system collects data based on the rule-based methods. This data includes various parameters and outcomes that are essential for fine-tuning the AI model.
4. Triggering Transfer Learning: Once a sufficient amount of training data has been collected, the transfer learning framework is triggered. This framework utilizes the collected data to update the model weights, ensuring that the AI model is fine-tuned and optimized for the current environment and user requirements.
5. Model Update and Deployment: After the transfer learning process is completed, the updated AI model is deployed. The system then resumes using the AI model for enhanced performance, continuously monitoring its accuracy and effectiveness. By incorporating these steps, the enhanced TFLM framework supports efficient transfer learning on resource-constrained devices like modem MCU, enabling real-time model adaptation and optimization, but the present disclosure is not limited thereto.

In some embodiments, the role of the weights (such as the weight data SW) may be that of values to be learned and adjusted. In the enhanced TFLM framework, the weights are numerical parameters within the neural network that are adjusted to minimize the loss and constitute core model parameters.

In this embodiment, during the initialization phase, the system first reads the built-in weights and biases from the TFLite model, thereby initializing the model using pretrained parameters. Furthermore, the weights are model parameters that serve as the target of backpropagation.

In some embodiments, the weights (such as the weight data SW) may be adjusted through the following mechanism: the system computes the gradients of the loss function with respect to each model parameter (weight), but the present disclosure is not limited thereto.

In this embodiment, the system then performs a backpropagation algorithm, updating the model parameters based on the computed gradients with the goal of reducing the loss. At the end of each training batch, the system performs backpropagation to update the weights within the retrain_op_node, but the present disclosure is not limited thereto.

In some embodiments, the handling of “gradients” within the enhanced TFLM framework may involve a process of first computing and then collecting them:
1. Gradients may be “computed.” The enhanced TFLM framework incorporates functionality for computing gradients. Processor 120 may compute gradients by calculating the partial derivatives of the loss function with respect to each model parameter. During the retraining procedure, for each iteration of the internal loop corresponding to a given batch_num, the system performs a step of “Calculate loss & gradients.”
2. Gradients may be “collected.” Within the batch-training structure, the computed gradients are accumulated and collected. Immediately after the “Calculate loss & gradients” step, the next step is “Collect gradients,” in which the gradients computed for the current batch are accumulated.
3. Application after collection. The collected gradients are subsequently used for actual model updates. The system performs backward propagation to update the weights within the retrain_op_node. This step adjusts the model parameters based on the collected gradients in order to minimize the loss.

In this embodiment, in summary, in each small training iteration, the system first computes the gradients corresponding to the loss of the current data batch, then accumulates and collects these computed gradients, and finally applies the collected gradients to perform weight updates, but the present disclosure is not limited thereto.

In some embodiments, compared with conventional techniques, by leveraging the existing rule-based methods for data collection and integrating them with our transfer learning framework, the transfer learning device 100 of the present disclosure may ensure continuous improvement and adaptation of AI models on resource-constrained platforms like modem MCU, but the present disclosure is not limited thereto.

In some embodiments, compared with conventional techniques, the transfer learning device 100 of the present disclosure may obtain the enhanced TFLM framework. By integrating loss calculation, gradient computation, and backpropagation into TensorFlow Lite Micro, the transfer learning device 100 may have significantly extended its capabilities. The enhanced TFLM framework may now perform transfer learning, making it suitable for resource-limited platforms like modem MCU, but the present disclosure is not limited thereto.

In some embodiments, compared with conventional techniques, the transfer learning device 100 of the present disclosure may improve model adaptability. The ability to fine-tune pre-trained models directly on the device allows for real-time adaptation to local data. This ensures that the models remain relevant and perform optimally in diverse and dynamic environments, such as different subway systems. However, the present disclosure is not limited thereto.

In some embodiments, compared with conventional techniques, the transfer learning device 100 of the present disclosure may optimize for resource-constrained devices. The added methods are designed to be lightweight and efficient, ensuring that the fine-tuning process can be executed within the limited computational resources of modem MCU. This optimization is critical for maintaining performance and efficiency on resource-constrained platforms. However, the present disclosure is not limited thereto.

In some embodiments, compared with conventional techniques, by extending TensorFlow Lite Micro with these transfer learning capabilities, the transfer learning device 100 of the present disclosure may provide a robust solution to the challenges of model adaptation, data privacy, and resource optimization, making it a powerful tool for modem applications. However, the present disclosure is not limited thereto.

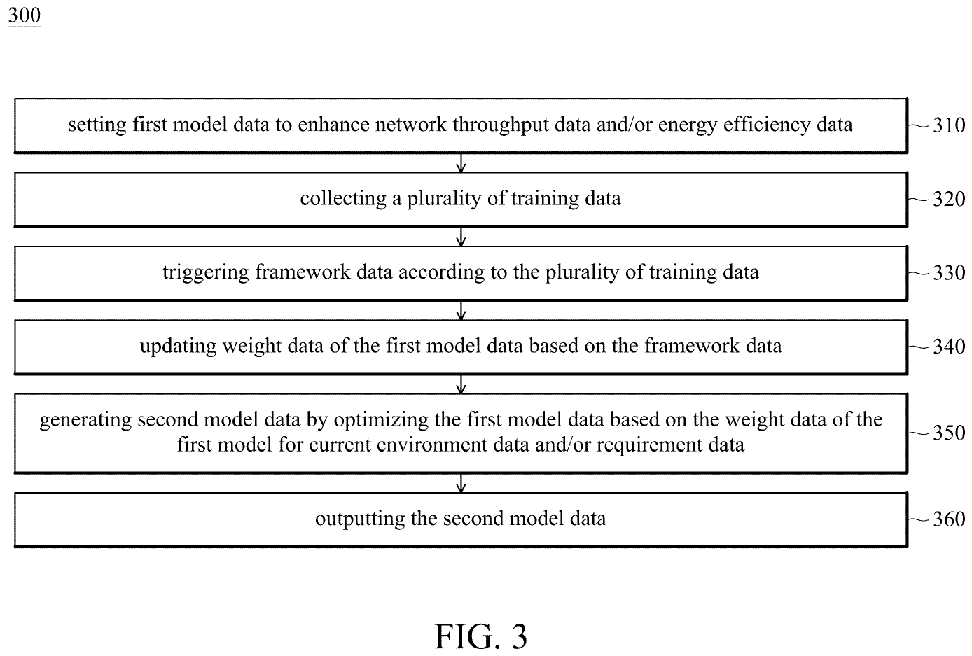

FIG. 3 is a schematic flowchart of a transfer learning method according to one embodiment of the present disclosure. As shown in FIG. 3, in one embodiment, the transfer learning method 300 may include the plurality of steps 310 to 360.

Please refer to FIG. 1, FIG. 2, and FIG. 3, the following provides a detailed description of the plurality of steps 310 to 360.

In the step 310, setting first model data to enhance network throughput data and/or energy efficiency data.

In one embodiment, the processor 120 (or the modem microcontroller) may set first model data FM to enhance network throughput data SNT and/or energy efficiency data SEF.

In the step 320, collecting a plurality of training data.

In one embodiment, the processor 120 (or the modem microcontroller) may collect the plurality of training data ST.

In the step 330, triggering framework data according to the plurality of training data.

In one embodiment, the processor 120 (or the modem microcontroller) may trigger framework data FR according to the plurality of training data ST.

In the step 340, updating weight data of the first model data based on the framework data.

In one embodiment, the processor 120 (or the modem microcontroller) may update weight data SW of the first model data FM based on the framework data FR.

In the step 350, generating second model data by optimizing the first model data based on the weight data of the first model data for current environment data and/or requirement data.

In one embodiment, the processor 120 (or the modem microcontroller) may generate second model data SM by optimizing the first model data FM based on the weight data SW of the first model data FM for current environment data SCE and/or requirement data SR.

In the step 360, outputting the second model data.

In one embodiment, the processor 120 (or the modem microcontroller) may output the second model data SM.

In one embodiment, the plurality of training data ST is related to the network throughput data SNT and/or the energy efficiency data SEF.

In one embodiment, the framework data FR is related to a transfer learning data STL.

It should be understood that the above steps need not be performed sequentially, and each feature of the embodiments shown in figure1 to FIG. 3 may be applied to the transfer learning method 300 illustrated in FIG. 3.

In one embodiment, the transfer learning method 300 further includes the following steps: triggering framework data FR by a modem microcontroller; updating the weight data SW of the first model data FM based on the framework data FR by the modem microcontroller; and generating the second model data SM by optimizing the first model data FM based on the weight data SW of the first model data FM by the modem microcontroller.

In one embodiment, the transfer learning data STL includes tensorflow lite micro data.

In one embodiment, the framework data includes an enhanced tensorflow lite micro framework data. The first model data includes neural network model data. The tensorflow lite micro data is related to the modem microcontroller. The framework data FR includes location variability data and application variability data.

In one embodiment, the transfer learning method 300 further includes the following steps: obtaining a plurality of first weight data FC11A, FC12A, FC13A, and FC14A from the framework data FR by a modem microcontroller; and initializing the framework data FR with a plurality of pre-trained parameters by the modem microcontroller.

In one embodiment, the plurality of first weight data FC11A, FC12A, FC13A, and FC14A is related to the weight data of the first model data FM. The plurality of pre-trained parameters include the plurality of first weight data FC11A, FC12A, FC13A, and FC14A. The framework data is related to the first model data FM.

In one embodiment, the transfer learning method 300 further includes the following steps: calculating batch data according to the requirement data SR by the modem microcontroller; and updating the plurality of first weight data FC11A, FC12A, FC13A, and FC14A according to a number of the batch data by the modem microcontroller.

In one embodiment, the requirement data SR includes user setting data.

In one embodiment, the transfer learning method 300 further includes the following steps: obtaining bias data from the framework data FR by the modem microcontroller; and updating the bias data according to the number of the batch data by the modem microcontroller.

In one embodiment, the plurality of pre-trained parameters include the bias data.

In one embodiment, the transfer learning method 300 further includes the following steps: triggering the framework data FR to perform inference a number of times corresponding to a batch size by the modem microcontroller; and obtaining epoch data according to the number of times corresponding to the batch size by the modem microcontroller.

In one embodiment, the batch size is related to the batch data.

In one embodiment, the transfer learning method 300 further includes the following steps: calculating loss data according to the first model data FM and the second model data SM by the modem microcontroller; and calculating gradient data according to the loss data and the plurality of first weight data FC11A, FC12A, FC13A by the modem microcontroller.

In one embodiment, the first model data FM and the second model data SM are related to the framework data FM.

In one embodiment, the transfer learning method 300 further includes the following steps: running backward propagation data to update the plurality of first weight data FC11A, FC12A, FC13A, and FC14A into a plurality of second weight data FC11B, FC12B, FC13B, and FC14B in a first node according to the loss data and/or the gradient data by the modem microcontroller; setting the plurality of second weight data FC21B, FC22B, FC23B, and FC24B in a second node by the modem microcontroller; and returning the loss data and validation result data to the framework data FR by the modem microcontroller.

In one embodiment, the memory 110 includes the plurality of first weight data FC11A, FC12A, FC13A, and FC14A. The memory 110 includes the first node. The framework data FR includes the second node.

In one embodiment, the transfer learning method 300 further includes the following steps: calculating the loss data through a Mean Squared Error method by the modem microcontroller; collecting the gradient data according to the epoch data by the modem microcontroller; and running the backward propagation data through an optimizer by the modem microcontroller.

In one embodiment, the optimizer includes one of an Adaptive Moment Estimation and a Root Mean Square Propagation.

In some embodiments, the transfer learning method 300 may be implemented by the transfer learning device 100, but the present disclosure is not limited thereto. In some embodiments, the transfer learning method 300 may be implemented by a non-transitory computer-readable storage medium, but the present disclosure is not limited thereto. In some embodiments, the transfer learning method 300 may be implemented by other systems or servers, but the present disclosure is not limited thereto.

Therefore, according to the technical content of the present disclosure, the transfer learning device and transfer learning method shown in the embodiment of the present disclosure can achieve the effect of performing self-learning and transfer learning in the modem microcontroller.

Furthermore, by leveraging the existing rule-based methods for data collection and integrating them with our transfer learning framework, the transfer learning device 100 of the present disclosure may ensure continuous improvement and adaptation of AI models on resource-constrained platforms like modem MCU.

In addition, the transfer learning device 100 of the present disclosure may obtain the enhanced TFLM framework. By integrating loss calculation, gradient computation, and backpropagation into TensorFlow Lite Micro, the transfer learning device 100 may have significantly extended its capabilities. The enhanced TFLM framework may now perform transfer learning, making it suitable for resource-limited platforms like modem MCU.

Furthermore, the transfer learning device 100 of the present disclosure may improve model adaptability. The ability to fine-tune pre-trained models directly on the device allows for real-time adaptation to local data. This ensures that the models remain relevant and perform optimally in diverse and dynamic environments, such as different subway systems.

In addition, the transfer learning device 100 of the present disclosure may optimize for resource-constrained devices. The added methods are designed to be lightweight and efficient, ensuring that the fine-tuning process can be executed within the limited computational resources of modem MCU. This optimization is critical for maintaining performance and efficiency on resource-constrained platforms.

Furthermore, by extending TensorFlow Lite Micro with these transfer learning capabilities, the transfer learning device 100 of the present disclosure may provide a robust solution to the challenges of model adaptation, data privacy, and resource optimization, making it a powerful tool for modem applications.

In addition, it should be understood that the ordinal terms such as “first” “second” and the like used in the specification and the claims are employed to modify elements and are not intended to indicate any temporal order of the element(s), nor do they imply any sequence between elements or any sequence in a manufacturing process.

The sole purpose of these ordinals is to clearly distinguish elements having similar names from one another. The same terms used in the specification and in the claims need not correspond; for example, an element referred to as a first element in the specification may be referred to as a second element in the claims.

The scope of protection of the present disclosure is not limited to the processes, machines, manufactures, compositions of matter, devices, methods, and steps described in the specific embodiments of the specification. Any person of ordinary skill in the art will understand from the teachings of the present disclosure that existing or future-developed processes, machines, manufactures, compositions of matter, devices, methods, and steps may be used, so long as they can perform substantially the same function or achieve substantially the same result as those in the embodiments described herein.

Accordingly, the scope of the present disclosure encompasses such processes, machines, manufactures, compositions of matter, devices, methods, and steps. Any embodiment or claim of the present disclosure does not need to achieve all of the objectives, advantages, and/or features disclosed herein.

The foregoing has outlined several embodiments to assist those of ordinary skill in the art in better understanding the concepts of the embodiments of the present disclosure. It should be understood by those of ordinary skill in the art that, based on the embodiments of the present disclosure, they may design or modify other processes and structures to achieve the same objectives and/or advantages as the embodiments described herein.

It should also be understood that such equivalent processes and structures do not depart from the spirit and scope of the present disclosure, and that various changes, substitutions, and alterations can be made without departing from the spirit and scope of the present disclosure.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A transfer learning device, comprising:
a memory, configured to store a plurality of commands and framework data; and
a processor, configured to execute following steps according to the plurality of commands of the memory:
setting first model data to enhance network throughput data and/or energy efficiency data;
collecting a plurality of training data;
triggering the framework data according to the plurality of training data;
updating weight data of the first model data based on the framework data;
generating second model data by optimizing the first model data based on the weight data of the first model data for current environment data and/or requirement data; and
outputting the second model data;
wherein the plurality of training data is related to the network throughput data and/or the energy efficiency data;
wherein the framework data is related to transfer learning data.

2. The transfer learning device as claimed in claim 1, wherein the processor comprises a microcontroller and a modem microcontroller;
wherein the transfer learning data comprises tensorflow lite micro data.

3. The transfer learning device as claimed in claim 2, wherein the framework data comprises an enhanced tensorflow lite micro framework data;
wherein the first model data comprises neural network model data;
wherein the tensorflow lite micro data is related to the modem microcontroller;
wherein the framework data comprises location variability data and application variability data.

4. The transfer learning device as claimed in claim 2, wherein
the modem microcontroller executes the following steps according to the plurality of commands of the memory:
obtaining a plurality of first weight data from the framework data; and
initializing the framework data with a plurality of pre-trained parameters;
wherein the plurality of first weight data is related to the weight data of the first model data;
wherein the plurality of pre-trained parameters comprise the plurality of first weight data;
wherein the framework data is related to the first model data.

5. The transfer learning device as claimed in claim 4, wherein
the modem microcontroller executes the following steps according to the plurality of commands of the memory:
calculating batch data according to the requirement data; and
updating the plurality of first weight data according to a number of the batch data;
wherein the requirement data comprises user setting data.

6. The transfer learning device as claimed in claim 5, wherein
the modem microcontroller executes the following steps according to the plurality of commands of the memory:
obtaining bias data from the framework data; and
updating the bias data according to the number of the batch data;
wherein the plurality of pre-trained parameters comprise the bias data.

7. The transfer learning device as claimed in claim 5, wherein
the modem microcontroller executes the following steps according to the plurality of commands of the memory:
triggering the framework data to perform inference a number of times corresponding to a batch size; and
obtaining epoch data according to the number of times corresponding to the batch size;
wherein the batch size is related to the batch data.

8. The transfer learning device as claimed in claim 7, wherein
the modem microcontroller executes the following steps according to the plurality of commands of the memory:
calculating loss data according to the first model data and the second model data; and
calculating gradient data according to the loss data and the plurality of first weight data;
wherein the first model data and the second model data are related to the framework data.

9. The transfer learning device as claimed in claim 8, wherein
the modem microcontroller executes the following steps according to the plurality of commands of the memory:
running backward propagation data to update the plurality of first weight data into a plurality of second weight data in a first node according to the loss data and/or the gradient data;
setting the plurality of second weight data in a second node; and
returning the loss data and validation result data to the framework data;
wherein the memory comprises the plurality of first weight data;
wherein the memory comprises the first node;
wherein the framework data comprises the second node.

10. The transfer learning device as claimed in claim 9, wherein
the modem microcontroller executes the following steps according to the plurality of commands of the memory:
calculating the loss data through a Mean Squared Error method;
collecting the gradient data according to the epoch data; and
running the backward propagation data through an optimizer;
wherein the optimizer comprises one of an Adaptive Moment Estimation and a Root Mean Square Propagation.

11. A transfer learning method, comprising:
setting first model data to enhance network throughput data and/or energy efficiency data;
collecting a plurality of training data;
triggering framework data according to the plurality of training data;
updating weight data of the first model data based on the framework data;
generating second model data by optimizing the first model data based on the weight data of the first model data for current environment data and/or requirement data; and
outputting the second model data;
wherein the plurality of training data is related to the network throughput data and/or the energy efficiency data;
wherein the framework data is related to transfer learning data.

12. The transfer learning method as claimed in claim 11, further comprising:
triggering the framework data by a modem microcontroller;
updating the weight data of the first model data based on the framework data by the modem microcontroller; and
generating the second model data by optimizing the first model data based on the weight data of the first model data by the modem microcontroller;
wherein the transfer learning data comprises tensorflow lite micro data.

13. The transfer learning method as claimed in claim 12, wherein the framework data comprises an enhanced tensorflow lite micro framework data;
wherein the first model data comprises neural network model data;
wherein the tensorflow lite micro data is related to the modem microcontroller;
wherein the framework data comprises location variability data and application variability data.

14. The transfer learning method as claimed in claim 12, further comprising:
obtaining a plurality of first weight data from the framework data by the modem microcontroller; and
initializing the framework data with a plurality of pre-trained parameters by the modem microcontroller;
wherein the plurality of first weight data is related to the weight data of the first model data;
wherein the plurality of pre-trained parameters comprise the plurality of first weight data;
wherein the framework data is related to the first model data.

15. The transfer learning method as claimed in claim 14, further comprising:
calculating batch data according to the requirement data by the modem microcontroller; and
updating the plurality of first weight data according to a number of the batch data by the modem microcontroller;
wherein the requirement data comprises user setting data.

16. The transfer learning method as claimed in claim 15, further comprising:
obtaining bias data from the framework data by the modem microcontroller; and
updating the bias data according to the number of the batch data by the modem microcontroller;
wherein the plurality of pre-trained parameters comprise the bias data.

17. The transfer learning method as claimed in claim 15, further comprising:
triggering the framework data to perform inference a number of times corresponding to a batch size by the modem microcontroller; and
obtaining epoch data according to the number of times corresponding to the batch size by the modem microcontroller;
wherein the batch size is related to the batch data.

18. The transfer learning method as claimed in claim 17, further comprising:
calculating loss data according to the first model data and the second model data by the modem microcontroller; and
calculating gradient data according to the loss data and the plurality of first weight data by the modem microcontroller;
wherein the first model data and the second model data are related to the framework data.

19. The transfer learning method as claimed in claim 18, further comprising:
running backward propagation data to update the plurality of first weight data into a plurality of second weight data in a first node according to the loss data and/or the gradient data by the modem microcontroller;
setting the plurality of second weight data in a second node by the modem microcontroller; and
returning the loss data and validation result data to the framework data by the modem microcontroller;
wherein a memory comprises the plurality of first weight data;
wherein the memory comprises the first node;
wherein the framework data comprises the second node.

20. The transfer learning method as claimed in claim 19, further comprising:
calculating the loss data through a Mean Squared Error method by the modem microcontroller;
collecting the gradient data according to the epoch data by the modem microcontroller; and
running the backward propagation data through an optimizer by the modem microcontroller;
wherein the optimizer comprises one of an Adaptive Moment Estimation and a Root Mean Square Propagation.
